(19) United States
(12) Patent Application Publication
(10) Pub. No.: US 2016/0078650 A1
(43) Pub. Date: Mar. 17, 2016

(54) DRAWING DATA GENERATION DEVICE AND DRAWING DEVICE

(71) Applicant: GEO TECHINICAL LABORATORY CO., LTD., Fukuoka-shi (JP)

(72) Inventors: Kiyonari KISHIKAWA, Fukuoka-shi (JP); Eiji TESHIMA, Fukuoka-shi (JP); Masatoshi ARAMAKI, Fukuoka-shi (JP); Masashi UCHINOUMI, Fukuoka-shi (JP); Masaru NAKAGAMI, Fukuoka-shi (JP); Tatsuya AZAKAMI, Fukuoka-shi (JP)

(21) Appl. No.: 14/859,058

(22) Filed: Sep. 18, 2015

Related U.S. Application Data
(63) Continuation of application No. PCT/JP2014/001528, filed on Mar. 18, 2014.

(30) Foreign Application Priority Data
Mar. 21, 2013 (JP) 2013-057496

(51) Int. Cl. G06T 11/20; G01C 21/00; G06F 17/30; G06T 11/60

(52) U.S. Cl. CPC G06T 11/203; G06T 11/60; G01C 21/00; G06F 17/30061; G06F 17/30321

(57) ABSTRACT

A drawing data generation device performs an integration process on map data so as to integrate line data for drawing linear features such as roads, such that a drawing speed of a map image is improved. The line data is grouped by the line type and the line width. The integration process links thin solid lines L1 and L3 by a non-display line LA1, and links thick solid lines L2, L4 and L5 by non-display lines LA2 and LA3, for example, so as to integrate the line data of a plurality of lines into integrated line data for an integral line formed of linked lines in a same group. Drawing a map using the map data in which the line data is integrated reduces the call counts for a line function for drawing lines provided in a graphics, thereby shortening

### CLAIM OF PRIORITY

This application is a Continuation of International Patent Application No. PCT/JP2014/001528, filed on Mar. 18, 2014, which claims priority to Japanese Patent Application No. 2013-057496, filed on Mar. 21, 2013, each of which is hereby incorporated by reference.

### BACKGROUND OF THE INVENTION

1. Field of the Invention

The present invention relates to a drawing device that draws an image using a graphics library, and a drawing data generation device that generates data for drawing.

2. Description of the Related Art

In the field of electronic maps used for display in navigation systems and computers, a map is drawn on a display by referring to map data provided in the form of polygon data. A drawing function called a graphics library is generally used for such drawing. Typical examples of the graphics library used for three-dimensional drawing include OpenGL and DirectX. Using such a graphics library enables images to be drawn efficiently at high speeds.

The graphics library has restrictions in use, but polygon data as the drawing object may not satisfy such restrictions. In this case, polygon data should be processed to meet the restrictions of the graphics library. As one example of such processing, Japanese Patent Laid-Open Application No. JP 2003-187256A discloses a technique of divisionally drawing polygons based on an upper limit value set with respect to the number of vertexes processable by the graphics library.

When the polygon data to be drawn are large-volume data consisting of a large number of polygons, such as map data, a process may be performed to reduce the data volume for the purpose of increasing the drawing speed. Japanese Patent Laid-Open Application No. JP 2003-187256A discloses a technique of skipping some vertexes in the course of drawing polygons in the case of a large angle between sides, so as to increase the drawing speed of polygons.

### BRIEF DESCRIPTION OF THE INVENTION

In the field of electronic maps, along with the popularization of three-dimensional maps that display the shapes of features three-dimensionally and the need for three-dimensional drawing, there is a significant increase in volume of polygon data to be drawn. In the application of a three-dimensional map to an automotive navigation system, it is required to draw the three-dimensional map in real time. There is accordingly a need to shorten the time required for drawing. A further improvement in drawing speed is accordingly needed to sufficiently meet such requirements, increase of the data volume and reduction of the drawing time.

The improvement in drawing speed is not limited to drawing electronic maps but is a common need in drawing images. An object of the invention is accordingly to enhance the drawing speed of an image using a graphics library.

According to one embodiment of the invention, there is provided a drawing data generation device that generates drawing data for drawing an image using a graphics library, wherein the graphics library has a line function that sequentially connects points specified by line data to draw a line. The drawing data generation device comprises: an original database that stores original data to be drawn; and a line data integrator that integrates a plurality of line data among the original data to line data of one integral line. The line data integrator extracts a plurality of line data, which share a common setting of the line function for drawing, among line data included in the original data. The line data integrator generates data to link end points spatially away from each other among end points of the line data by a hidden line, so as to connect and integrate the plurality of extracted line data to line data of one integral line.

In the case of drawing using a graphics library, the line function is to be called when each line is drawn. This calling takes a relatively long processing time. An increase in number of line data to be drawn accordingly increases the number of calls for the line function and increases the total processing time.

The embodiment of the invention, on the other hand, links a plurality of line data by a hidden line, so as to integrate the plurality of line data to line data of one integral line. It is sufficient to call the line function only once to draw the integrated line data. This shortens the time required for drawing. Integration of lines naturally increases the number of points constituting line data to be drawn by one call for the line function, which is a factor to increase the processing time. Regardless of this time-increasing factor, reduction in number of calls for the line function has the greater effect on reduction of the processing time and thereby shortens the total processing time.

In the case of drawing using the graphics library, display/non-display of a line is readily changed over with respect to each interval between points. Linkage between link data by a hidden line is readily achieved by defining a new line between line data and setting this interval as non-display.

Line data as the object of integration are those sharing the common settings of the line function for drawing. For example, lines having the common line thickness and the common line type may be specified as the object of integration. Which lines should be specified as the object of integration depends on the graphics library used.

According to one embodiment of the invention, when the line function has a function of drawing a line while sequentially changing a display mode from a first display mode specified for one end point of the line to a second display mode specified for another end point of the line, the drawing data generation device may further comprise: a dummy point generator that additionally generates dummy points, which are to be newly used for linkage, to overlap with end points that are to be linked with each other by the hidden line during the integration, wherein the line data integrator may connect the dummy points by a hidden line.

The line function of the graphics library may have blending function, i.e., the function of gradually changing the display mode, such as the line color, from a first point to a second point. For example, when “red color” is specified at the first point and “blue color” is specified at the second point, the line function having this blending function causes a line between the first point and the second point to be drawn with gradually changing the color from red to blue.

When an end point of a first line (called first end point) and an end point of a second line (called second end point) included in original data are to be linked with each other by a hidden line, this line function may cause the first line and the second line to be drawn with gradually increasing the degree of transparency toward the first end point and toward the second end point.

The embodiment of the invention, on the other hand, additionally generates dummy points at the first end point and at the second end point and subsequently links the dummy points by a hidden line. This causes the first line and the second line to be drawn adequately without being affected by the hidden line.

According to one embodiment of the invention, the line data integrator may link end points having a shorter distance between each other, among the end points spatially away from each other. This reduces the total length of a resulting integral line, thus further shortening the time for drawing a line.

According to another embodiment of the invention, the original database may store unique original index information with respect to each line data, in relation to the line data, and the line data integrator may generate unique integration index information regarding a shape and an attribute of the integrated line data, separately from the original index information.

Even after integration of lines, there is a need to make lines of original data distinct from hidden lines added for integration. The attributes such as the color and the line type may be specified for each line data of the original data. Such information should be kept in a referable state.

The above embodiment keeps the original index information related to each line data and accordingly causes the shape and the attributes assigned to the line data of the original data to be referable. The index information on the integrated line data of the resulting integral line is also generated simultaneously. This advantageously facilitates the processing of the integrated line data of the integral line.

The invention is not limited to the aspect of the drawing data generation device described above but may be implemented by a variety of other aspects, for example, a drawing device described below.

According to another aspect, there is provided a drawing device that draws an image using a graphics library, wherein the graphics library has a line function that sequentially connects points specified by line data to draw a line. The drawing device comprises: an original database that stores original data to be drawn, which is generated in a unit of a mesh of a predetermined size; a line drawing data processor that, when there are a plurality of meshes as an object of drawing, virtually links and integrates end points of line data included in different meshes to line data of one integral line; and a drawing section that performs drawing by calling the line function based on the integrated line data. The drawing device according to this aspect performs drawing by connecting lines between meshes. This reduces the number of calls for the line function and thereby shortens the total time required for drawing.

One embodiment of the drawing device of the invention may further comprise the drawing data generation device according to any one of the aspect and the embodiments described above to integrate a plurality of line data included in each of the plurality of meshes, with respect to the each mesh. The line drawing data processor may integrate line data which has been integrated in advance with respect to the each mesh. This embodiment not only integrates the lines included in each mesh but integrates lines between meshes. This further reduces the number of calls for the line function.

The invention may not necessarily include all the features described above but may be configured appropriately with partial omission or by combination of these features. The invention may also be configured as a generation method performed by the computer to generate drawing data or as a drawing method performed by the computer to draw an image. The invention may also be configured as a computer program that causes the computer to generate drawing data or that causes the computer to draw an image. The invention may further be configured as a computer-readable non-transitory storage medium in which such a computer program is stored.

### BRIEF DESCRIPTION OF THE DRAWINGS

FIG. 1 is a diagram illustrating the configuration of a route guidance system;

FIG. 2 is a diagram illustrating the data structure of an original map database;

FIG. 3A is a diagram illustrating outline of a line data integration process;

FIG. 3B is a diagram illustrating outline of a line data integration process;

FIG. 3C is a diagram illustrating outline of a line data integration process;

FIG. 4A is a flowchart showing the line data integration process; and

FIG. 4B is a flowchart showing the line data integration process; and

FIG. 5 is a flowchart showing a route guidance process.

### DETAILED DESCRIPTION OF EMBODIMENTS OF THE INVENTION

### Embodiment 1

The following describes an embodiment of the present invention configured as a route guidance system that performs route search and route guidance, while drawing a map. In the route guidance system, part involved in drawing a map using a graphics library corresponds to the drawing device of the invention. Part involved in generation of data for this purpose corresponds to the drawing data generation device of the invention.

The drawing object of the invention is not limited to maps, so that the invention is not limited to the aspect of the route guidance system but is applicable to any of various drawing devices that draw an image using a graphics library.

### A. System Configuration

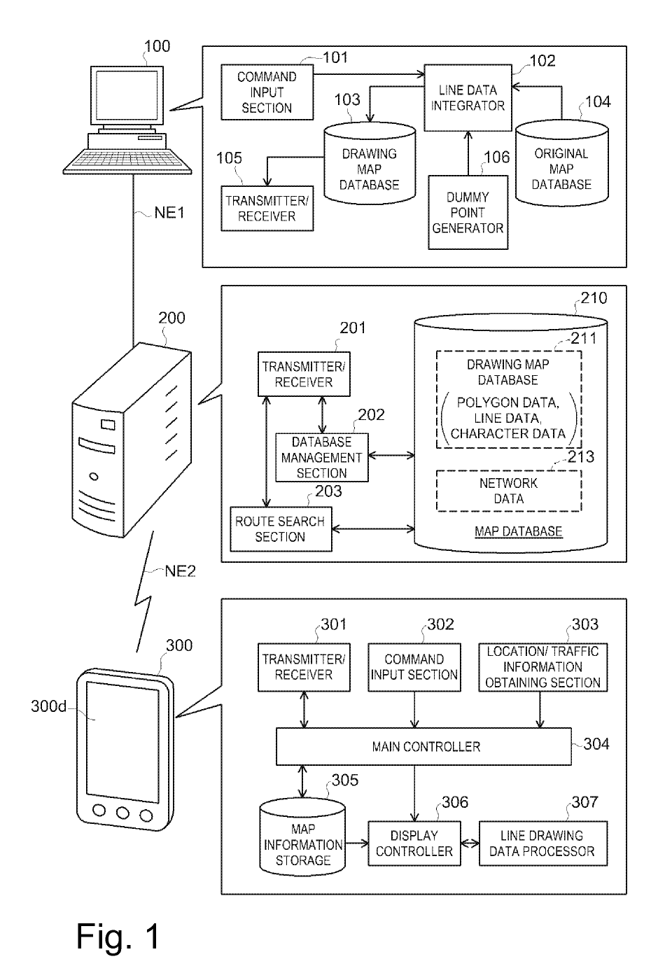

FIG. 1 is a diagram illustrating the configuration of a route guidance system. The route guidance system is configured as a system that guides a route from a departure place to a destination specified by the user, while displaying a map in a terminal 300, based on data provided by a server 200. The server 200 and the terminal 300 are connected with each other by means of a network NE2, such as the Internet. According to the embodiment, the terminal 300 used is a smartphone including a CPU, a RAM and a ROM, but any of a variety of devices that are capable of displaying an electronic map, such as a cell phone, a personal computer or a tablet terminal may also be used as the terminal 300.

A drawing data generation device 100 that generates drawing data for efficiently drawing a map is also illustrated in FIG. 1. The drawing data generation device 100 is configured by using a personal computer including a CPU, a RAM and a ROM, as a device to generate a drawing map database from an original map database 104. The drawing data generation device 100 is connected with the server 200 by means of a network NE1, and the generated drawing map database is stored in the server 200.

The drawing data generation device 100, the server 200 and the terminal 300 respectively have functional blocks as illustrated. These functional blocks are configured as software configuration by installing computer programs for implementing the respective functions according to this embodiment, but may alternatively be configured as hardware configuration.

The functions of the drawing data generation device 100, the server 200 and the terminal 300 shown in this embodiment are only illustrative, and the route guidance system may be configured as a standalone device that implements all the functions by a single unit. Alternatively the route guidance system may be configured as a distribution system including a greater number of servers and the like than those illustrated. The configurations of the respective devices are sequentially described below.

The following describes the configuration of the drawing data generation device 100.

The original map database 104 is provided as a database that stores polygon data representing the shapes of features to be drawn in a map and line data. According to this embodiment, the original map database 104 stores three-dimensional map data representing three-dimensional shapes. The data stored in the original map database 104 may be used directly to draw a three-dimensional map by, for example, perspective projection. According to this embodiment, in order to enhance the drawing speed, the drawing data generation device 100 processes the original map database 104 to generate a drawing map database 103.

A command input section 101 inputs the operator's instructions with regard to, for example, processing of the original map database 104. A line data integrator 102 links line data representing a plurality of lines included in the original map database 104 as the above processing to generate line data of one integral line. This process may be hereafter referred to as integration. A dummy point generator 106 generates dummy points for linkage to overlap with end points of line data as the object of processing. The reason for generation of dummy points is described later, along with the process outline of integration.

The drawing map database 103 stores drawing map data which is processed by the line data integrator 102 for the purpose of enhancing the drawing speed. A transmitter/receiver 105 sends and receives data to and from the server 200. According to the embodiment, the map data stored in the drawing map database 103 are sent by the transmitter/receiver 105 via the network NE1 to the server 200.

The following describes the configuration of the server 200.

A map database 210 stores a drawing map database 211 and network data 213. The drawing map database 211 stores map data generated by the drawing data generation device 100 or more specifically polygon data representing shapes of features, line data and character data. The network data 213 are data for route search expressing roads by links and nodes.

A database management section 202 manages input and output of data into and from the map database 210. According to this embodiment, the database management section 202 updates the drawing map database 211 generated by the drawing data generation device 100 and reads map data required for display a map from the map database 210.

A route search section 203 utilizes the network data 213 to search a route from a departure place to a destination specified by the user of the terminal 300. Any of known techniques such as Dijkstra's algorithm may be applied for the route search. A transmitter/receiver 201 sends and receives various data and commands to and from the drawing data generation device 100 and the terminal 300 via the network NE1 and via the network NE2.

The following describes the configuration of the terminal 300.

A main controller 304 consolidates and controls the operations of the respective functional blocks provided in the terminal 300. A transmitter/receiver 301 sends and receives data and commands to and from the server 200 via the network NE2. A command input section 302 inputs the user's instructions with regard to, for example, route guidance. The instructions include, for example, specification of a departure place and a destination of route guidance and specification of a display scale for displaying a map.

A location/traffic information obtaining section 303 obtains the current location of the terminal 300 from a sensor such as GPS (global positioning system) and obtains information on traffic congestion and traffic restrictions via the network NE2.

A map information storage 305 temporarily stores the drawing map database 211 obtained from the server 200 in the course of displaying a map. According to this embodiment, the terminal 300 does not store in advance all the map data but appropriately obtains required map data according to the map display range from the server 200. The map information storage 305 stores the map data thus obtained, as well as the result of route search.

A display controller 306 uses the map data stored in the map information storage 305 to display a map on a display 300d of the terminal 300. The display controller 306 has a graphics library provided for drawing polygons and lines. Drawing is performed appropriately by calling a function of the graphics library. For example, OpenGL or DirectX may be used as the graphics library.

A line drawing data processor 307 processes map data, in order to enhance the drawing speed by the display controller 306. As described above, according to the embodiment, the map data have been processed in advance for the purpose of enhancing the drawing speed by the drawing data generation device 100. There is, however, a limitation in processing range in the state that the display range of a map is not yet specified. The line drawing data processor 307 accordingly performs available processing at the time when a map is displayed.

### B. Data Structure

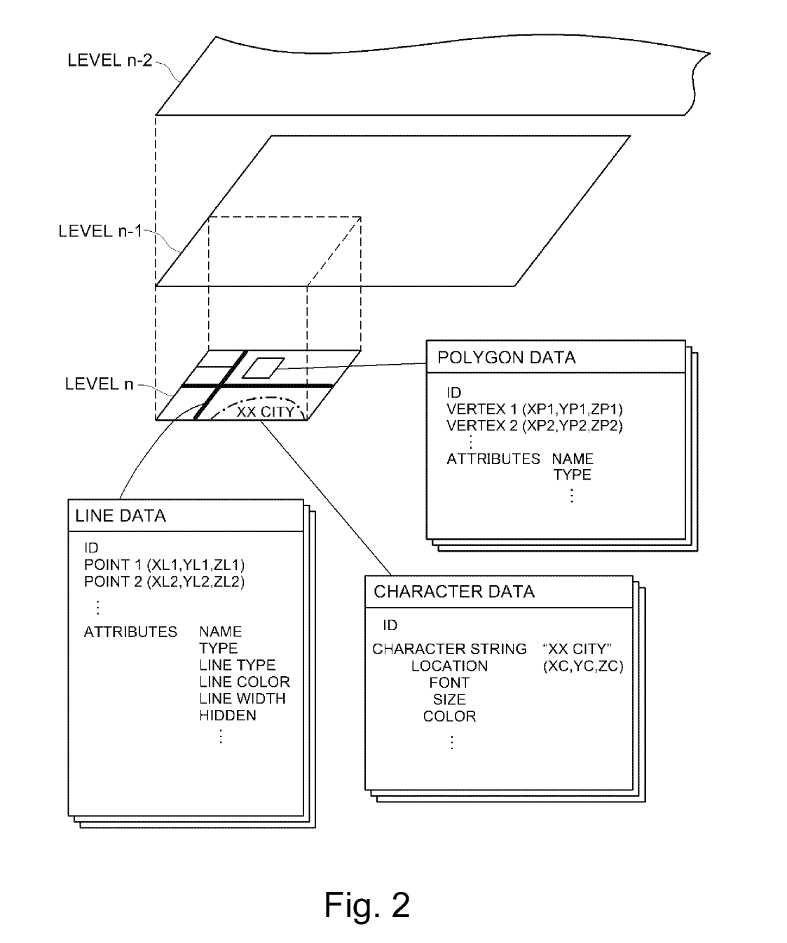

FIG. 2 is a diagram illustrating the data structure of the original map database. The original map database is stored in multiple levels, i.e., in multiple levels of details. The outline of multiple levels is shown in the upper portion of illustration. A level n stores data having a high level of details in the unit of a mesh in a rectangular shape of a predetermined size. A level n−1 stores data having a lower level of details than the level n, for example, data of main roads and buildings. The level n−1 also stores data in the unit of a mesh, but the mesh size is larger than that of the level n. A level n−2 stores map data having a further lower level of details in the unit of a larger mesh.

The structure of the map data is described with regard to the data in the level n as an example.

Line data are data used to draw linear features such as roads and railway in a map. The line data is generated in the unit of a feature, and an “ID” as unique index information is assigned to each line data. The shape of line data is expressed by a set of position coordinates of characteristic points defining a line, e.g., point 1 (XL1, YL1, ZL1) and point 2 (XL2, YL2, ZL2). The coordinate values of these points may be stored in an area for each line data. Alternatively the coordinate values may be stored in a separate area from the area for each line data, and a pointer for identifying the storage location may be stored in the area for each line data.

“Attributes” set for each line data include the “name” of a feature expressed by the line data, the “type” of the feature such as the road type, the “line type”, “line color” and “line width” for drawing a line and specification of display/ no display.

Character data are data representing characters to be displayed in a map. The character data are managed by assigning an “ID” as unique index information to each character data. A “character string” shows characters to be displayed in a map, for example, “XX City”, and a “location” shows coordinate values (XC, YC, ZC) of a position where the characters are to be displayed. Parameters required for displaying characters, for example, font, size and color, are also specified as the character data.

Polygon data are data representing shapes of buildings and other features. The polygon data is also generated in the unit of a feature and is managed by an “ID” as unique index information. The shape of a polygon is expressed by a set of coordinates of vertexes defining the polygon, e.g., vertex 1 (XP1, YP1, ZP1) and vertex 2 (XP2, YP2, ZP2). The “name” of a feature represented by a polygon and the “type” such as building or pond are specified as “attributes”.

FIG. 2 illustrates the data structure of the original map database. The drawing map database has a similar structure. The drawing map database of the embodiment is used to enhance the drawing speed by assigning additional information to line data without significantly changing the data structure itself.

### C. Generation of Drawing Data

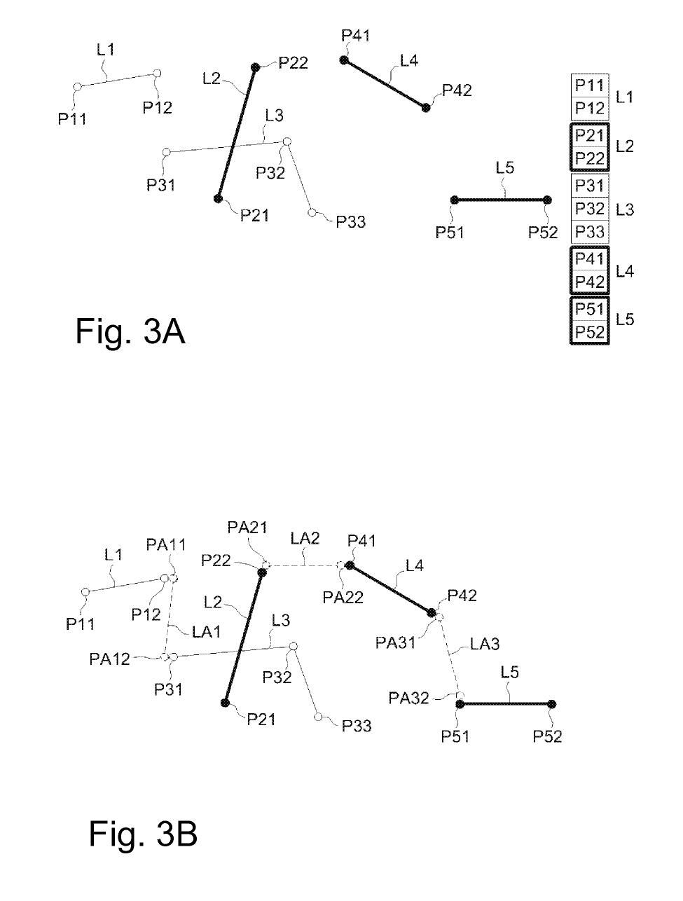

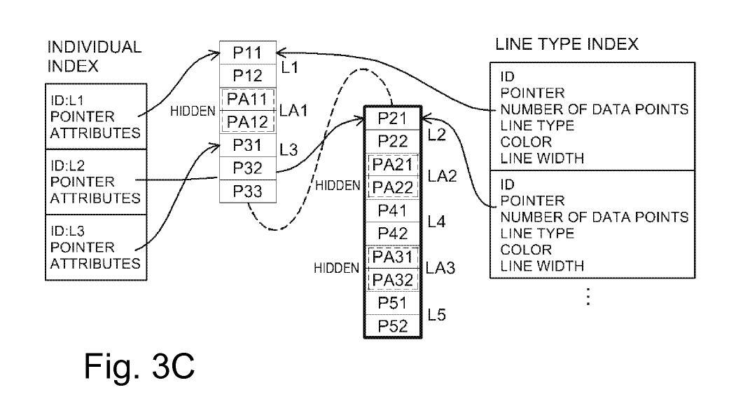

FIGS. 3A through 3C are a diagram illustrating the outline of a line data integration process. FIG. 3A shows line data prior to integration. In the illustrated example, a map includes lines L1 and L3 drawn by thin lines representing, for example, narrow lanes in the city and lines L2, L4 and L5 drawn by thick lines representing, for example, main roads like national roads. The state of storage of line data corresponding to these lines is illustrated on the right side of illustration. In this illustrated example, characteristic points defining each line are collectively stored in a separate memory area from the memory area for the ID and the attributes of the line data (FIG. 2). A pointer for identifying the memory area, in which a characteristic point is stored, is stored, as the coordinate array of the characteristic point, in the area for the line data.

Points P11 and P12 are stored with regard to the line L1 in the memory area for storage of characteristic points. Points P21 and P22 are also stored with regard to the line L2. Similarly, points P31 to P33, points P41 and P42 and points P51 and 52 are respectively stored with regard to the lines L3, L4 and L5. The respective lines L1 to L5 are treated separately in the line data, so that the characteristic points are stored separately with regard to the respective lines.

FIG. 3B shows a process of integration. The integration process links lines which share the common settings of the graphics library, and connects lines of the same line thickness according to this embodiment. In the description below, among characteristic points defining a line, points located on ends of the line are called “end points”.

In the case of integrating the lines L1 and L3 drawn by thin lines, the process connects one end point P12 of the line L1 with one end point P31 of the line L3 by a hidden line LA1. The thickness of the hidden line LA1 is the same as that of the lines L1 and L3.

The hidden line LA1 may connect any of end points P11 and P12 of the line L1 with any of end points P31 to P33 of the line L3. This embodiment, however, selects the combination of the end point P12 and the end point P31, in order to minimize the distance of the linkage. The hidden line LA1 may directly connect the end point P12 with the end point P31, but the process of this embodiment generates a dummy point PA11 to overlap with the end point P12 and a dummy point PA12 to overlap with the end point P31 and links the dummy points PA11 and PA12 with each other to define the hidden line LA1.

Additional generation of the dummy points PA11 and PA12 is attributed to the following reason.

The line function of the graphic library has a blending function, i.e., a function of gradually changing a display mode, for example, line color, from a first characteristic point to a second characteristic point. If the point P12 is directly connected with the point P31 by the line LA1 and this section is set to be hidden and not displayed, the blending function causes a phenomenon that the line L1 is drawn to gradually increase the degree of transparency from the point P11 toward the point P12. Similarly the line L3 is drawn to gradually increase the degree of transparency from the point P32 toward the point P31.

Additional generation of the dummy points PA11 and PA12, on the other hand, causes the line between the points P11 and P12 and the line between the points P31 and P32 to be adequately drawn without being affected by the hidden and non-displayed line LA1. In a strict sense, blending occurs from the point P12 toward the dummy point PAW The point P12 and the dummy point PA11 are, however, located at the same position, so that the result of blending is invisible by the drawn line.

Similarly, in the case of integrating the lines L2, L4 and L5 drawn by thick lines, the process connects one end point P22 of the line L2 with one end point P41 of the line L4 by a hidden line LA2 and additionally connects an end point P42 of the line L4 with an end point P51 of the line L5 by a hidden line LA3. The thickness of the hidden lines LA2 and LA3 is the same as that of the lines L2, L4 and L5. Any of end points of the lines L2, L4 and L5 may be connected as described above. The process generates dummy points PA21, PA22, PA31 and PA32 to respectively overlap with the end points P22, P41, P42 and P51 and links these dummy points to define the hidden lines LA2 and LA3.

This integration process causes the lines L1 and L3 drawn by thin lines to be integrated via the hidden line LA1 to one integral line. This integration process also causes the lines L2, L4 and L5 drawn by thick lines to be integrated via the hidden lines LA2 and LA3 to one integral line.

As a result, while it is required to call the line function five times to draw the lines L1 to L5 prior to the integration, it is required to call the line function only a total of two times, once for drawing thin lines and once for drawing thick lines, after the integration. The integration accordingly reduces the number of calls for the line function and thereby shortens the total processing time. The line function is capable of controlling display/non-display of a line with respect to each section. The process of drawing the lines LA1, LA2 and LA3 as hidden lines provides the same drawing result as the process of drawing the lines L1 to L5 individually.

FIG. 3C shows data after the line integration process. The characteristic points of each line data are collectively stored with regard to the respective lines L1 to L5 as shown in FIG. 3A, prior to the integration process. In this state, line data of the thin lines L1 and L3 and line data of the thick lines L2, L4 and L5 are not classified but are stored in a mixture.

After the integration, as shown in FIG. 3C, it is preferable to collectively store the characteristic points of the line L1, the points of the hidden line LA1 and the characteristic points of the line L3 with regard to the thin lines, in order to draw the thin lines by one line function. Similarly, with regard to the thick lines, in order to draw the thick lines by one line function, it is preferable to collectively store the characteristic points of the line L2, the points of the hidden line LA2, the characteristic points of the line L4, the points of the hidden line LA3 and the characteristic points of the line L5. Changing the storage location of data, however, significantly increases the process load of the integration process. The embodiment accordingly uses a pointer identifying the storage location of a characteristic point.

The left side of FIG. 3C shows individual indexes of the respective lines L1 to L3. The index is one form of line data shown in FIG. 2 and denotes a form that does not store the position coordinates of each characteristic point but stores a pointer identifying a memory area for storing the characteristic point. For example, a pointer identifying a memory area, in which the characteristic point P11 is stored, is stored as the index with respect to the line L1. Similarly, a pointer identifying a memory area in which the characteristic point P21 is stored and a pointer identifying a memory area in which the characteristic point P31 is stored are respectively stored as the index with respect to the line L2 and as the index with respect to the line L3.

The right side of FIG. 3C shows line type indexes of the respective lines after integration. According to this embodiment, the lines drawn by the thin lines and the lines drawn by the thick lines are respectively integrated, so that two line type indexes are generated. The line type index has the similar structure as that of the individual index. A unique “ID” is assigned to each integrated line.

The shape of the integrated line is specified by a pointer. With respect to the thin lines, a pointer for the point P11 as the end point is stored. The number of data denotes the number of points to be sequentially read from the stored pointer. For example, when data of the lines L1, LA1 and L3 forming an integral thin line are stored in consecutive areas, seven points should sequentially be read from the point P11, so that 7 is stored as the number of data.

When the points of the hidden line LA1 and the points of the line L3 are stored in discrete areas that are not consecutive to the storage area of the points P11 and P12 of the line L1, on the other hand, a pointer identifying the storage location of the point PA11 of the hidden line LA1 and a pointer identifying the storage location of the point P31 of the line L3 are also stored in the line type index.

Similarly, with respect to the thick lines, a pointer for the point P21 as the end point of the thick line and the number of data are stored in relation to an “ID”. When the points of the lines L2, LA2, L4, LA3 and L5 forming an integral thick line are stored in discrete areas, pointers identifying the storage locations of the respective points are also stored in the line type index.

Providing both the individual index and the line type index has the following advantages. By referring to the individual index, the respective points and the respective lines are recognizable as individual separate lines prior to integration. By referring to the line type index, the respective points and the respective lines are recognizable as one integrated line. Providing both the individual index and the line type index enables the points and the line to be used in two different ways, as individual lines and as an integrated line.

The following describes the details of the process of integration shown in FIGS. 3A through 3C.

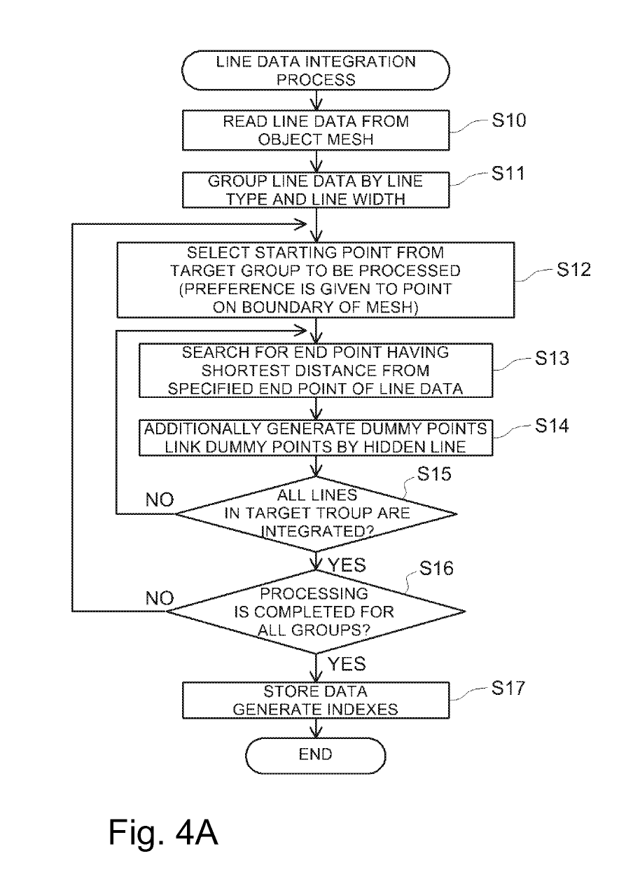

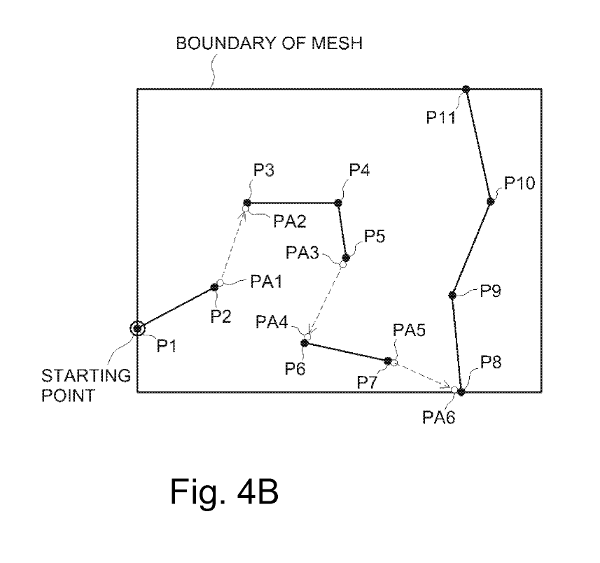

FIG. 4A is a flowchart showing the line data integration process. The line data integration process is performed by the line data integrator 102 and the dummy point generator 106 of the drawing data generation device 100 and is performed by the CPU of the drawing data generation device 100 as the hardware configuration. FIG. 4A is a flowchart, and FIG. 4B illustrates an example of processing. Lines included in original data prior to integration are shown by solid lines, and hidden lines generated in the process of integration are shown by broken lines.

When the process starts, the CPU reads line data from an object mesh to be processed (step S10). The original map database 104 of the embodiment stores map data in the unit of a mesh as described previously with FIG. 2, so that the integration process is performed in the unit of a mesh. The object mesh may be specified manually by the operator or may be specified automatically, for example, according to a predetermined sequence.

The CPU groups the read line data by the line type and the line width (step S11). This is because lines having the same line type and the same line widths are subject to integration. The object of grouping depends on the drawing restriction in the line function of the graphics library. According to the embodiment, the line function has the restriction that lines having either one or both of different line types and different line widths should not be drawn at once. The line data are accordingly grouped by the line type and the line width. For example, when the employed line function is capable of drawing lines having the same line type at once irrespective of different line widths, line data may be grouped only by the line type.

The CPU subsequently selects one of the groups thus created as a target group to be processed and selects a starting point with respect to the selected target group (step S12). The starting point forms an end point of an integral line after integration. The starting point may be arbitrarily selected among end points of lines included in the target group. According to this embodiment, an end point located on the boundary of a mesh is preferentially selected. This is because sequential linkage from a line located on the boundary of a mesh is likely to reduce the total length of a resulting integral line. Additionally, using the end point of the integral line on the boundary of a mesh advantageously facilitates integration between meshes described later.

In the illustrated example of FIG. 4B, a point P1 on the boundary of a mesh is selected as the starting point. The CPU subsequently follows line data from the selected starting point to specify an end point and searches for an end point having the shortest distance from the specified end point of line data (step S13). In the illustrated example of FIG. 4B, the CPU follows line data from the starting point P1 to specify an end point P2. There are end points P3, P5 and P6 as other end points located in the neighborhood of the end point P2. The CPU calculates the distances from the end point P2 to the respective end points P3, P5 and P6 and selects the end point P3 having the shortest distance from the end point P2. This end point P3 is determined as an end point to be linked with the specified end point P2 by a hidden line.

When finding the end points to be linked, the CPU additionally generates dummy points at the respective end points to be linked and links the dummy points by a hidden line (step S14). In the illustrated example of FIG. 4B, the CPU additionally generates a dummy point PA1 at the end point P2 and a dummy point PA2 at the end point P3 and links the dummy points PA1 and PA2 by a hidden line as shown by the broken line.

The CPU repeats the processing of steps S13 and S14 described above until all the lines included in the target group are linked (step S15).

In the illustrated example of FIG. 4B, the CPU follows line data from the selected end point P3 to reach an end point P5 and selects an end point P6 having the shortest distance from the end point P5 (step S13). The CPU then additionally generates a dummy point PA3 at the end point P5 and a dummy point PA4 at the end point P6 and links the dummy points PA3 and PA4 by a hidden line.

The CPU subsequently follows line data from the selected end point P6 to reach an end point P7 and selects an end point P8 having the shortest distance from the end point P7 (step S13). The CPU then additionally generates a dummy point PA5 at the end point P7 and a dummy point PA6 at the end point P8 and links the dummy points PA5 and PA6 by a hidden line. This results in connecting all the lines to one integral line. This completes the processing with respect to the target group at step S15.

The CPU repeats the above series of processing with respect to each group (step S16) and stores the results of integration into the drawing map database 103 and generates indexes (step S17). The details of the indexes are described previously with reference to FIGS. 3A through 3C.

The line data are integrated to one integral line with respect to each line type and each line width in each mesh by the above processing, so that the line data is drawn by simply calling the line function only once with respect to each line type and each line width.

### D. Route Guidance Process

The following describes a route guidance process as an example of displaying a map using drawing map data. The route guidance process guides a route specified by route search, while displaying a map. The route search is performed by the server 200, prior to route guidance.

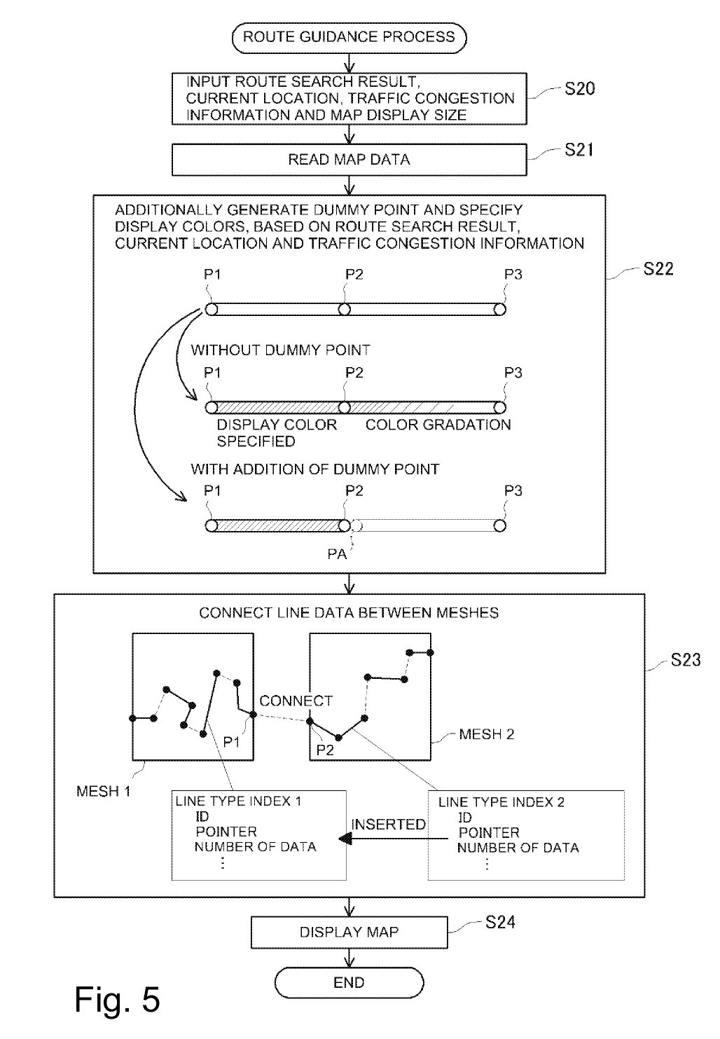

FIG. 5 is a flowchart showing the route guidance process. This process is mainly performed by the display controller 306 and the line drawing data processor 307 of the terminal 300 and is performed by the CPU of the terminal 300 as the hardware configuration.

When the process starts, the terminal 300 inputs a route search result, a current location, traffic congestion information and a map display size (step S20). The route search result is obtained from the server 200. The current location is detected by utilizing a sensor such as GPS. The traffic congestion information is obtained, for example, via the Internet. The map display size is specified by the user.

The terminal 300 subsequently reads map data required for displaying a map (step S21). According to this embodiment, the terminal 300 first reads data stored in the map information storage 305. When the read map data are insufficient for displaying a map, the terminal 300 obtains required data from the server 200.

The terminal 300 then additionally generates a dummy point and specifies a display color, based on the route search result, the current location and the traffic congestion information (step S22). This processing aims to display a searched route or any road in traffic congestion in a different color from the color of ordinary roads.

The outline of this processing is illustrated. With respect to a road passing through points P1, P2 and P3, the line between the points P1 and P2 is assumed to be a searched route or a road in traffic congestion and should be displayed in a different color.

The middle drawing in step S22 illustrates an example that specifies display colors without adding a dummy point. When a certain display color is specified for the line between the points P1 and P2, the blending function of the line function causes a color gradation in the display between the points P2 and P3. For example, it is assumed that the road passing through the points P1, P2 and P3 is ordinarily displayed in red color and blue color is specified for the line between the points P1 and P2 to express a searched route. In this case, accompanied with display of the line between the points P1 and P2 in blue color, the line between the points P2 and P3 is displayed to gradually change the color from blue to read from the point P2 toward the point P3.

The bottom drawing in step S22 illustrates an example that adds a dummy point. A dummy point PA is additionally generated at the same position as that of the point P2 of the original data, and display colors are then specified. For example, blue color is specified for the line between the points P1 and P2, and red color is specified for the line between the points PA and P3. This causes the line between the points PA and P3 to be displayed in the specified color without being affected by the display color of the line between the points P1 and P2. In a strict sense, blending occurs between the points P2 and PA. These points P2 and PA are, however, located at the same position, so that the blending effect is invisible.

After specifying the display colors, the terminal 300 connects line data between meshes (step S23).

The outline of this processing is illustrated. The lines of the same line type and the same line width are integrated to one integral line in each mesh by the line data integration process (FIGS. 4A and 4B). The respective lines in meshes 1 and 2 are the results of integration in these meshes. Line type indexes 1 and 2 are provided for the respective integrated lines, and the characteristic points defining each integral line are identified by pointers.

In the case of displaying a map, map data may be used across different meshes. In such cases, the procedure of the embodiment connects lines having the common line type and the common line width between meshes, in order to further enhance the drawing speed. This process employs the same method as that of line integration in each mesh. More specifically, the process groups integrated lines included in different meshes by the line type and the line width and links end points having the shortest distance among the end points of the integrated lines by a hidden line.

When end points to be linked have different position coordinates, in order to avoid the effects of the blending function, the process additionally generates dummy points at the respective end points and subsequently links the dummy points. When end points have the same position coordinates, on the other hand, additional generation of dummy points may be omitted, since the effects of the blending function are invisible.

On completion of the preprocessing described above, the terminal 300 displays a map on the display 300d (step S24). The graphics library is used for display of a map. The line function is called for display of line data. This embodiment not only integrates lines in a mesh but additionally connects lines between meshes. This further reduces the number of calls for the line function and enhances the drawing speed.

### E. Advantageous Effects and Modifications

The embodiment describes above integrates the lines having the common line type and the common line width in the process of displaying a map. This reduces the number of calls for the line function provided in the graphics library and thereby shortens the total time required for the display process. In the case of drawing a map using a graphics library, calling for the line function takes a relatively long time. The reduction in number of calls for the line function accordingly has the significant effect on reduction of the total processing time.

The embodiment performs the integration process at two stages, i.e., stationary process and dynamic process. The stationary process means a process of performing the integration process in the unit of a mesh in advance to generate a drawing map database (FIGS. 4A and 4B). This enhances the drawing speed in the unit of a mesh. The dynamic process means a process of connecting line data between meshes in the process of displaying a map by the terminal 300 (FIG. 5). This further enhances the drawing speed in the case of displaying a map across a plurality of meshes.

The foregoing describes the embodiment of the invention. The invention may not necessarily have all the functions of the embodiment described above but may have only part of such functions. The invention may have additional functions other than those described above.

The embodiment describes a route guidance system, but the invention may be configured as a system that displays a map irrespective of route guidance. The invention is not limited to maps but is generally applicable to a drawing device that draws an image using a graphic library.

The invention is not limited to the above embodiment but may be implemented by a variety of configurations within the scope of the invention. For example, part configured by the hardware in the embodiment may be implemented by the software configuration, and vice versa.

The invention is applicable to improve the drawing speed of images using a graphics library.

What is claimed is:

1. A drawing data generation device that generates drawing data for drawing an image using a graphics library, wherein
the graphics library has a line function that sequentially connects points specified by line data to draw a line,
the drawing data generation device comprising:
an original database that stores original data to be drawn; and
a line data integrator that integrates a plurality of line data among the original data to line data of one integral line, wherein
the line data integrator extracts a plurality of line data, which share a common setting of the line function for drawing, among line data included in the original data, and
the line data integrator generates data to link end points spatially away from each other among end points of the line data by a hidden line, so as to connect and integrate the plurality of extracted line data to line data of one integral line.

2. The drawing data generation device according to claim 1, wherein
the line function has a function of drawing a line while sequentially changing a display mode from a first display mode specified for one end point of the line to a second display mode specified for another end point of the line,
the drawing data generation device further comprising:
a dummy point generator that additionally generates dummy points, which are to be newly used for linkage, to overlap with end points that are to be linked with each other by the hidden line during the integration, wherein
the line data integrator connects the dummy points by a hidden line.

3. The drawing data generation device according to claim 1, wherein
the line data integrator links end points having a shorter distance between each other, among the end points spatially away from each other.

4. The drawing data generation device according to claim 2, wherein
the line data integrator links end points having a shorter distance between each other, among the end points spatially away from each other.

5. The drawing data generation device according to claim 1, wherein
the original database stores unique original index information regarding a shape and an attribute of each line data, in relation to the line data, and
the line data integrator generates unique integration index information regarding a shape and an attribute of the integrated line data, separately from the original index information.

6. The drawing data generation device according to claim 2, wherein
the original database stores unique original index information regarding a shape and an attribute of each line data, in relation to the line data, and
the line data integrator generates unique integration index information regarding a shape and an attribute of the integrated line data, separately from the original index information.

7. The drawing data generation device according to claim 3, wherein
the original database stores unique original index information regarding a shape and an attribute of each line data, in relation to the line data, and
the line data integrator generates unique integration index information regarding a shape and an attribute of the integrated line data, separately from the original index information.

8. A drawing device that draws an image using a graphics library, wherein the graphics library has a line function that sequentially connects points specified by line data to draw a line,
the drawing device comprising:
an original database that stores original data to be drawn, which is generated in a unit of a mesh of a predetermined size;
a line drawing data processor that, when there are a plurality of meshes as an object of drawing, virtually links and integrates end points of line data included in different meshes to line data of one integral line; and
a drawing section that performs drawing by calling the line function based on the integrated line data.

9. The drawing device according to claim 8, further comprising a drawing data generation device that generates drawing data for drawing an image using a graphics library, wherein the graphics library has a line function that sequentially connects points specified by line data to draw a line,
the drawing data generation device comprising:
an original database that stores original data to be drawn; and
a line data integrator that integrates a plurality of line data among the original data to line data of one integral line,
wherein the line data integrator extracts a plurality of line data, which share a common setting of the line function for drawing, among line data included in the original data,
wherein the line data integrator generates data to link end points spatially away from each other among end points of the line data by a hidden line, so as to connect and integrate the plurality of extracted line data to line data of one integral line,
and wherein the line drawing data processor integrates line data which has been integrated with respect to the each mesh, thereby integrating the plurality of line data mesh by mesh.

10. The drawing device according to claim 9, wherein
the line function has a function of drawing a line while sequentially changing a display mode from a first display mode specified for one end point of the line to a second display mode specified for another end point of the line,
the drawing data generation device further comprising:
a dummy point generator that additionally generates dummy points, which are to be newly used for linkage, to overlap with end points that are to be linked with each other by the hidden line during the integration, wherein
the line data integrator connects the dummy points by a hidden line.

11. The drawing device according to claim 9, wherein
the line data integrator links end points having a shorter distance between each other, among the end points spatially away from each other.

12. The drawing device according to claim 10, wherein
the line data integrator links end points having a shorter distance between each other, among the end points spatially away from each other.

13. The drawing device according to claim 9, wherein
the original database stores unique original index information regarding a shape and an attribute of each line data, in relation to the line data, and
the line data integrator generates unique integration index information regarding a shape and an attribute of the integrated line data, separately from the original index information.

14. The drawing device according to claim 10, wherein
the original database stores unique original index information regarding a shape and an attribute of each line data, in relation to the line data, and
the line data integrator generates unique integration index information regarding a shape and an attribute of the integrated line data, separately from the original index information.

15. The drawing device according to claim 11, wherein
the original database stores unique original index information regarding a shape and an attribute of each line data, in relation to the line data, and
the line data integrator generates unique integration index information regarding a shape and an attribute of the integrated line data, separately from the original index information.

16. A drawing data generation method performed by a computer to generate drawing data for drawing an image using a graphics library, wherein
the graphics library has a line function that sequentially connects points specified by line data to draw a line,
the drawing data generation method comprising:
reading original data to be drawn from an original database which stores the original data to be drawn; and
integrating a plurality of line data among the original data to line data of one integral line, wherein
the integrating the plurality of line data extracts a plurality of line data, which share a common setting of the line function for drawing, among line data included in the original data, and
the integrating the plurality of line data generates data to link end points spatially away from each other among end points of the line data by a hidden line, so as to connect and integrate the plurality of extracted line data to line data of one integral line.

17. A drawing method performed by a computer to draw an image using a graphics library, wherein
the graphics library has a line function that sequentially connects points specified by line data to draw a line,
the drawing method comprising:
reading original data to be drawn from an original database that stores the original data which is generated in a unit of a mesh of a predetermined size;
when there are a plurality of meshes as an object of drawing, virtually linking and integrating end points of line data included in different meshes to line data of one integral line; and
performing drawing by calling the line function based on the integrated line data.
